(19) United States
(12) Patent Application Publication
(10) Pub. No.: US 2011/0108402 A1
(43) Pub. Date: May 12, 2011

(54) ELECTRICAL ADAPTOR AND METHOD OF USE THEREOF

(76) Inventor: David Bowen, West Yorkshire (GB)

(21) Appl. No.: 12/992,404

(22) PCT Filed: May 12, 2009
(86) PCT No.: PCT/GB2009/001167

§ 371 Date: Jan. 11, 2011

(30) Foreign Application Priority Data
May 13, 2008 (GB) 0808596.1

(51) Int. Cl. H01H 43/00

(52) U.S. Cl. 200/33 R

(57) ABSTRACT

An electrical adaptor (100) is provided including first electrical connection means (116) for allowing electrical connection of the adaptor with an electrical socket (148) and/or electrical supply in use, at least second electrical connection means for allowing electrical connection of an electrical plug or further electrical connection with the adaptor, and timing means for electrical current to be supplied through said adaptor in use for one or more pre-determined time periods. The timing means includes at least first (102) and second (136) parts which are capable of undergoing relative movement in use between a first position, wherein electrical current can flow through said adaptor between the first and at least second electrical connection means, and a second position, wherein electrical current is prevented from flowing through the adaptor between the first and at least second electrical connection means.

This invention relates to an electrical adaptor and a method of use thereof.

Although the following description refers almost exclusively to an electrical adaptor in the form of a three pin electrical adaptor of a type commonly used in the United Kingdom, it will be appreciated by persons skilled in the art that the present invention can relate to any type of electrical adaptor, such as a two pin adaptor, single pin adaptor and/or the like, or indeed any type of electrical adaptor in which a complementary plug or connection can be inserted or engaged therewith to allow the flow of electrical charge between an electrical socket and electrical plug with which the adaptor is engaged with in use.

Conventionally if a user wishes to use an electrical appliance, such as for example an iron, the user locates the plug, typically attached to the iron at the end of an electrical cable running between the iron housing and the plug, in a wall electrical socket. The user then actuates a switch associated with the wall socket to allow electrical current to pass from a mains power supply, through the wall socket, along the plug pins to electrical connections internally of the plug and along the electrical cable to the iron. A further operational switch may be associated with the iron to allow the electrical current being passed along the electrical cable to make contact with electrical connections in the iron if required. Once the user has finished with the iron, the user may switch the iron off by operating the iron operational switch, the wall socket switch and/or removing the plug from the wall socket, thereby stopping the flow of electrical current from the mains power supply to the iron.

However, a common problem is that a user may forget to switch the iron or other electrical appliance off after use, particularly if the user is a child or elderly person. This can lead to a waste of electrical power and/or over heating of the appliance, which may result in fire and/or damage to the appliance or locality in which the appliance is located.

In an attempt to overcome this problem, it is known to provide timing devices which automatically switch the electricity supply to an appliance on and/or off after one or more pre-determined time periods. An example of such a timing device typically requires a user to first set the timing device to switch the electrical supply on at a first set time and to switch the electrical supply off at a second set time. This setting may require use of a tool. The timing device is then plugged into a wall socket and the electrical appliance is plugged into the timing device. However, it can be time consuming and fiddly to set/reset conventional timing devices and said devices may not be set to function when the user wishes to use the appliance. As such, a user will often not use the timing device.

A further example of a timing device is disclosed in the applicant's co-pending patent application PCT/GB2007/003786. The timing device is in the form of an electrical plug comprising a plug housing having first and second parts. Electrical pins are provided on one of the parts of the plug housing to allow electricity to flow from an electrical socket, with which the plug is engaged with in use, to the electrical pins. A movement mechanism is provided in the plug housing which is arranged to allow relative movement of the plug parts between a first position, wherein electrical charge can flow therebetween, and a second position, wherein the flow of electrical charge is prevented. The relative movement of the plug parts takes place over a pre-determined time period following actuation of the same. A problem with the abovementioned timing device is that a timing device is required to be provided with each item of electrical apparatus for which timed use is desired.

It is therefore an aim of the present invention to provide an electrical adaptor which overcomes the abovementioned problem.

It is a further aim of the present invention to provide a method of use of an electrical adaptor which overcomes the abovementioned problem.

According to a first aspect of the present invention there is provided an electrical adaptor, said adaptor including:
first electrical connection means for allowing electrical connection of the adaptor with an electrical socket and/or electrical supply in use;
at least second electrical connection means for allowing electrical connection of an electrical plug or further electrical connection with the adaptor; and
timing means for allowing electrical current to be supplied through said adaptor in use for one or more pre-determined time periods;
and wherein said timing means includes at least first and second parts, at least one of said parts capable of undergoing relative movement with respect to said other part in use between a first position, wherein electrical current can flow through said adaptor between the first and at least second electrical connection means, and a second position, wherein electrical current is prevented from flowing through the adaptor between the first and at least second electrical connection means.

The time taken for the movement between the at least first and/or second parts typically determines and/or substantially equates to the one or more pre-determined time periods.

The timing means typically provides operation of the adaptor, once actuated, for said one or more pre-determined time periods without further user actuation or intervention being required and, once said pre-determined time period has expired, the timing means moves the adaptor to an un-operational condition until further actuation of the timing means.

Preferably the first and/or second electrical connection means allow releasable engagement with the respective plug, socket and/or further electrical supply or connection in use.

Preferably the adaptor comprises a housing and the first part is attached to, comprises or is integrally formed with said housing. The second part is typically arranged to move relative to said first part or housing.

It will be appreciated that both the first and at least second parts can be arranged to move or at least one of the parts may be arranged to move with respect to another of said parts which is substantially fixed in use.

Preferably the second part is arranged to slidably move relative to said first part or housing when moving between said first and second positions, although other movement, such as rotation or pivotable movement could take place between or with the first and/or second parts if required. In one embodiment the second part can be at least partially slidably mounted to said first part.

Preferably the second part is arranged to move outwardly and/or inwardly relative to said first part and/or housing in use when moving between said first and second positions. Further preferably the movement is substantially perpendicular to a surface of said housing, such as for example the front surface of the housing or front surface of a wall socket. Yet further preferably the movement is in a substantially horizontal direction when the adaptor is in use in a socket.

The second part is arranged to undergo reciprocal and/or substantially linear movement when moving between said first and second positions.

In one embodiment the second part moves outwardly relative to the housing and/or first part when moving from the first position to the second position and inwardly relative to the housing and/or first part when moving from the second position to the first position.

Preferably a user is required to actuate the timing means for each pre-determined time period to allow relative movement between the at least first and second parts between the first and second positions. In one example, actuation of the timing means moves the second part from the second position to the first position.

In one embodiment the second part is arranged so as to be pushed inwardly of or relative to the first part or housing to allow actuation of the timing mechanism.

Thus, in one example, a user actuates the timing means by applying a force to the second part to move the same inwardly of the housing and/or first part to move the second part from the second position to the first position. The second part moves in the opposite direction to return to the second position.

Preferably biasing means are associated with the adaptor, first part and/or second part for biasing the second part from the first position to the second position. In one embodiment the biasing means includes any or any combination of resilient biasing means, pneumatic means, mechanical means, hydraulic means and/or the like.

The movement means associated with or forming part of the timing means for allowing movement between the at least first and second parts can include any or any combination of resilient biasing means, such as a compressed spring for example, pneumatic means, mechanical means, hydraulic means and/or the like.

In one embodiment the length of time the biased means takes to convert the potential energy to kinetic energy determines or substantially equals the one or more pre-determined time periods.

The first and second electrical connection means are typically provided on separate walls and/or faces of the adaptor housing. Preferably the second part is provided on a yet further separate wall or face to said first and second electrical connection means.

In one embodiment the separate walls and/or faces are typically provided at different angles to each other, such as for example adjacent walls or surfaces are provided substantially perpendicular to each other.

In one embodiment the housing includes at least a front face, rear face, top, base and side walls. Preferably the first electrical connection means are provided on a rear face of the adaptor housing. Further preferably the second electrical connection means are provided on a top wall of the housing. Although could be provided on a side wall or the front face instead or in addition to the top wall.

Preferably a recess or aperture is defined in the housing and/or first part and the second part is located at least partially in the recess or aperture. In the second position, a front surface of the second part is preferably substantially flush with a front surface of the housing and/or first part defining an opening to said recess. In the first position, the second part is recessed further within said recess or aperture relative to the first position. Yet further preferably the first part is located at or forms a rear surface of the housing defining said recess or aperture. The present invention can include any or any combination of the above.

The external surfaces of the first and second parts typically together form the external outline of the housing of the adaptor. Thus, in one embodiment the first and second parts are both external components of the adaptor.

Sealing means can be provided in or on the adaptor to prevent dirt and/or moisture from entering the adaptor housing or adaptor interior.

Control means can be provided on or associated with the adaptor for allowing the timing means on the adaptor to be moved between “on” and “off” conditions in use and/or to allow adjustment of the one or more pre-determined time periods.

For example, with the control means in the “off” condition, the adaptor could be used in a conventional manner without the timing mechanism being used. The adaptor could therefore be used for a time period longer the one or more pre-determined time periods. Alternatively, with the control means in the “off” condition, the adaptor may not be operational for any time period.

In one embodiment the second part has the external appearance of a conventional plug.

Written instruction, symbols, arrows and/or the like can be provided on the adaptor to allow a user to determine how to use the adaptor. For example, one or more arrows can be provided on the exterior of the adaptor housing to show a user the correct direction they are required to push in order to actuate the timing means.

The one or more pre-determined time periods can be pre-set by the manufacturer or could be selected by the user from a number of possible pre-determined time periods or selected arbitrarily by the user. Adjustment means can be provided to allow a user to select a pre-determined time period from a number of possible pre-determined time periods.

In one example, the uncoiling of a spring or resilient biasing means could determine the pre-determined time period.

The at least first and second electrical connection means can be Of the same type or different types. For example, one connection means could be a three pin arrangement and the other connection means could be a two pin socket or a three pin socket arrangement.

Internal electrical contacts can be provided in the first and/or second parts which are associated with the first and second electrical connection means. Electrical contact can be made between the first and second electrical contacts in the first position and can be broken in the second position. A skilled person will appreciate that any suitable electrical circuitry and contacts can be used to provide electrical flow between the first and second electrical connection means in the first position and to prevent electrical flow between the first and second electrical connection means in the second position.

According to a second aspect of the present invention there is provided a method of using an electrical adaptor, said method including the steps of:
engaging first electrical connection means of the adaptor with an electrical socket and/or electrical supply;
engaging at least second electrical connection means of the adaptor with an electrical plug or further electrical connection;
and actuating timing means on said adaptor to allow electrical current to flow through said electrical adaptor for one or more pre-determined time periods;
and wherein said timing means includes at least first and second parts, at least one of said parts capable of undergoing relative movement with respect to said other part following actuation between a first position, wherein electrical current can flow through said adaptor between the first and at least second electrical connection means, and a second position, wherein electrical current is prevented from flowing through the adaptor between the first and at least second electrical connection means.

According to a further aspect of the present invention there is provided an electrical adaptor, said electrical adaptor including first electrical connection means for allowing electrical connection of the adaptor with an electrical socket and/or electrical supply, and at least second electrical connection means for allowing electrical connection of the adaptor with an electrical plug of further electrical connection, and wherein said adaptor includes timing means for allowing current to be supplied through said adaptor for a single pre-determined time period.

According to a yet further aspect of the present invention there is provided a method of using an electrical adaptor.

Thus, the electrical adaptor of the present invention incorporates a timing mechanism which is simple and inexpensive to produce. In its simplest form, it allows a single pre-determined time period for electrical current to be supplied through the adaptor once it has been actuated in use. A user is not required to use any tools to actuate or set the timing mechanism of the adaptor, thereby making it easy to use. The timing mechanism is internal of the housing and cannot be accessed via a user externally.

An embodiment of the present invention will now be described with reference to the accompanying figures, wherein:

FIG. 1 is a perspective of an electrical adaptor according to an embodiment of the present invention;

FIG. 2 illustrates engagement of the adaptor in FIG. 1 in an electrical socket in use;

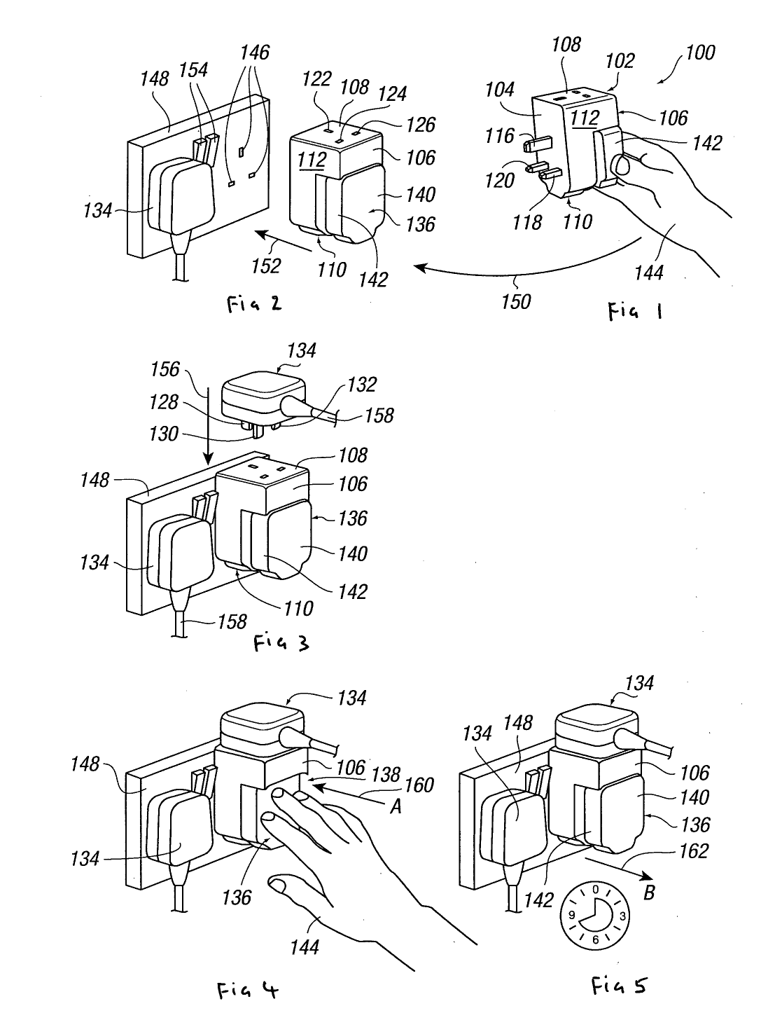

FIG. 3 illustrates engagement of the adaptor in FIG. 2 with an electrical plug;

FIG. 4 illustrates actuation of the timing mechanism for the electrical adaptor in FIG. 3;

FIG. 5 illustrates movement of the second part of the adaptor following actuation in FIG. 4;

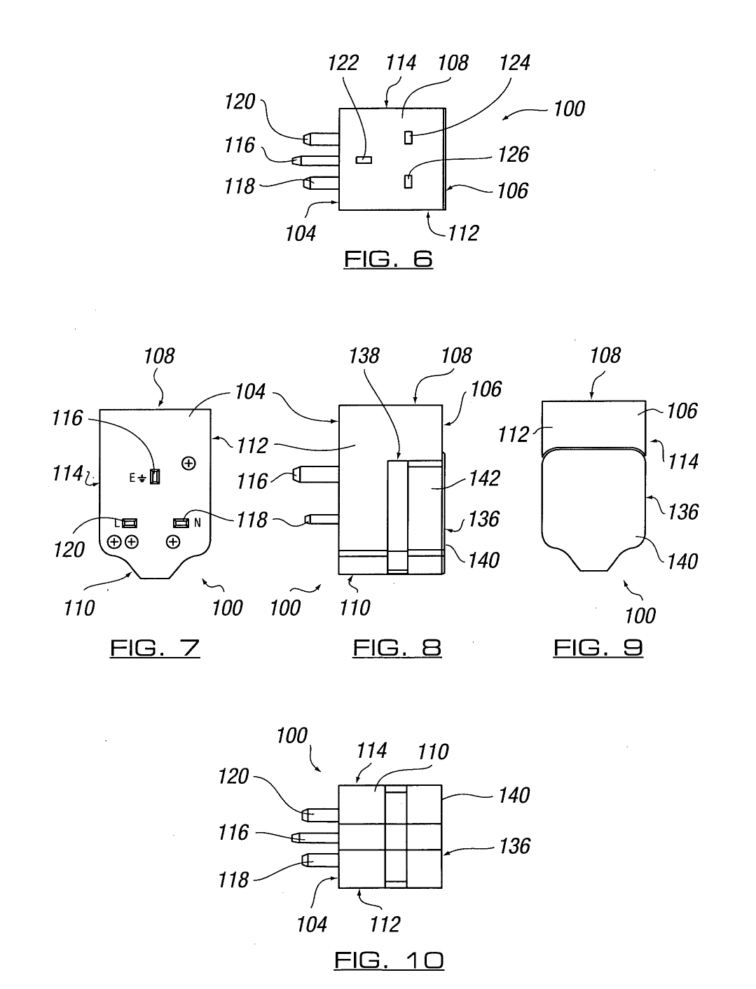

FIGS. 6-10 illustrate a top view, rear view, side view, front view and base view of the electrical adaptor in FIG. 1 respectively;

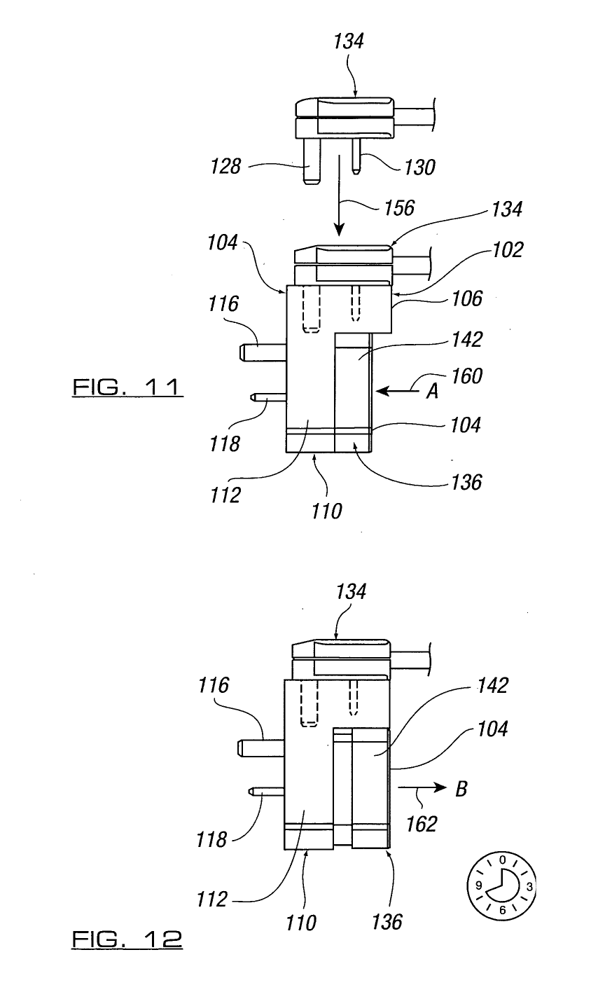

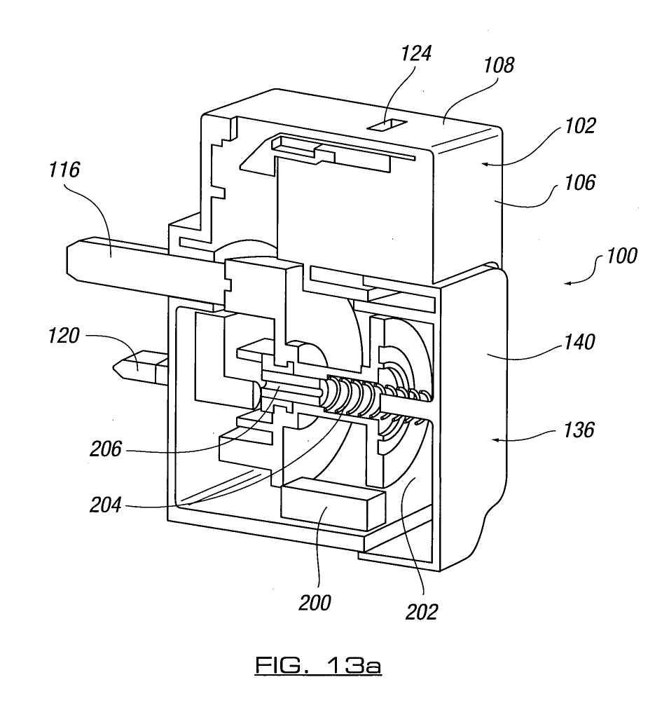

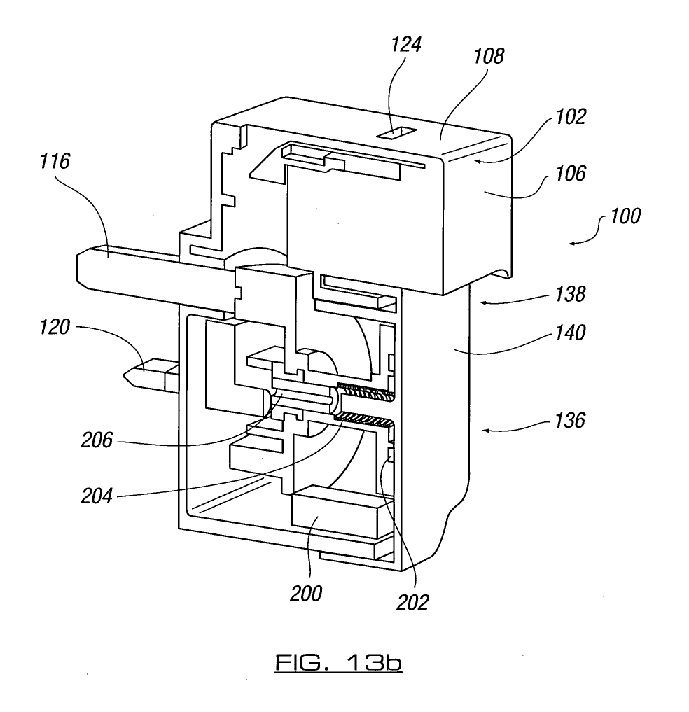

FIGS. 11 and 12 illustrate a side view of the electrical adaptor on actuation and following actuation respectively; and

FIGS. 13a and 13b show cross sectional views taken through the adaptor in one embodiment in an “off” or second position and an “on” or first position respectively.

Referring to the figures, there is illustrated an electrical adaptor 100 which incorporates a timing mechanism to allow electrical current to be supplied via the electrical adaptor in use for a pre-determined period of time.

The adaptor illustrated is for use with a conventional three pin electrical socket and a conventional three pin electrical plug. However, it will be appreciated that the present invention can be used with any type of wall socket or electrical plug.

Adaptor 100 comprises a housing or first part 102 including a rear face 104, front face 106, top 108, base 110 and side walls 112, 114. The rear face 104 is provided with conventional plug engagement means in the form of three spaced apart electrical pins; corresponding to an Earth pin 116, a Neutral pin 118 and a Live pin 120. The top face 106 is provided with three conventional socket apertures 122, 124, 126 for releasable engagement with three electrical pins 128, 130, 132 of a conventional electrical plug 134 as will be described in more detail below.

Adaptor 100 further comprises a second part 136 which is slidably movable relative to first part 102 between a first position, as shown in FIGS. 4, 11 and 13b, to a second position, as shown in FIGS. 3, 5, 12 and 13a. A recess 138 is defined in front face 106 of first part 102 and second part 136 is slidably mounted in said recess. More particularly, with the second part 136 in the second position, a front face 140 of second part 136 is substantially flush with front face 106 of first part 102. Side walls 142 of second part 136 are also substantially flush with or slightly recessed relative to side walls 112, 114 of first part 102, thereby allowing the second part is be moved inwardly of the first part in use. This provides the adaptor with an improved aesthetic appearance.

In use of the adaptor 100, a user 144 locates electrical pins 116, 118 and 120 into engagement with complementary apertures 146 on a conventional electrical wall socket 148, as shown by arrows 150, 152. The conventional wall socket 148 in the illustrations is a double wall socket having apertures for the location of two plugs, a plug and an adaptor or two adaptors in use. On/off switches 154 are provided on the front face of socket 148 to allow the supply of electrical current through the socket from a mains electrical supply to be moved between on/off conditions.

A user then brings the pins 123-132 of a conventional plug 134 into engagement with the complementary apertures 122-126 on top surface of first part 102 of adaptor 100, as shown by arrow 156 in FIG. 3. Conventional plug 134 has an electrical cable 158 joining the same to an item of electrical equipment for which an electrical supply is required to make the equipment operational in use.

When an electrical supply is required to be delivered to the item of electrical equipment joined to plug 134 for a pre-determined time period, a user actuates the timing mechanism of adaptor 100 by depressing second part 136 relative to first part 102. More particularly, user 144 applies a substantially horizontal force or force substantially perpendicular to the front face 106 of first part 102, as shown by arrow 160 in FIGS. 4 and 11, to move second part 136 inwardly of recess 138. This slidably moves second part 136 from the second or rest position ‘B’ to the first or actuated position ‘A’, wherein front face 140 is recessed within recess 138. When the user releases their grip of second part 136, said part 136 moves in an opposite and outwardly direction from the direction it was depressed, as shown by arrow 162 in FIGS. 5 and 12. The time taken for second part 136 to move from the first position to the second position substantially equals or is greater than the pre-determined period of time for which electrical current can flow through the adaptor.

With the second part 136 in the first position, electrical pins 128-132 are electrically connected, either directly or indirectly, to electrical pins 116-120. If switch 154 of socket 148 is also in an “on” condition, electrical current can flow from said socket 148 through the adaptor, into said plug 134 and to said electrical equipment. With the second part 136 in the second position, electrical pins 128-132 are electrical disconnected from electrical pins 116-120, thereby preventing electrical current flowing through said adaptor and to said electrical equipment.

Intermediate electrical contacts can be provided in said adaptor housing to allow electrical current to flow between pins 116-120 and pins 128-132 in use.

More particularly a switch 200 is provided which closes an electric circuit between the live pin 120 of the adaptor and the live pin associated with the plug 134 of the electrical appliance when the second part 136 is actuated and moved to the first position. The switch maintains closure of the electrical circuit during movement of the second part between the first and second positions. The switch breaks or opens the electrical circuits once the second part has reached the final second position.

A chamber 202 is defined in second part 136 and contains air when the adaptor is in the second position, as shown in FIG. 13a. On actuation of the second part 136, the air in forced out of chamber 202 as second part 136 moves further into the recess 138 of first part 102. Resilient biasing means in the form of a compression spring 204 provided between second part 136 and first part 102 in the interior thereof is compressed as second part 136 is moved to the first position and gradually uncoils under its inherent resilient bias as the second part 136 returns to the second position.

A further air chamber 206 is defined between the first and second parts which allows air to re-enter chamber 202 of second part 136 at a fixed or controlled rate as second part 136 moves from the first position to the second position. The combination of the passage of air back into chamber 202 and the resilient biasing force of spring 204 provide the pre-determined timing mechanism for which the switch 200 remains in an “on” position to close the electrical circuit.

The interior surface or surfaces of the first and/or second parts can be provided with suitable stop means to limit the movement between the first and second positions. Suitable support means can be, defined in the first and/or second parts to provide support of one or more internal components when assembled.

The movement mechanism used to allow second part to be moved between the first and second positions is typically a pneumatic mechanism which biases the second part to the second position. However, other movement mechanisms can be used.

The adaptor can be formed from any or any combination of suitable material, such as rubber, metal, plastic and/or the like. Preferably an insulating outer covering is provided on the adaptor to prevent electrical current passing from the adaptor housing to a user.

The adaptor 100 could be a multi-plug adaptor and could have apertures on the side walls, base and/or front wall thereof to allow further plugs to be engaged therewith.

At least a portion of second part 136 is telescopically mounted in a recess or aperture portion of the first part 102. The dimensions of said second part portion are slightly smaller than the dimensions of the first part aperture or recess to form a snug fit between the same whilst allowing telescopic movement.

The timing means can be re-actuated after use substantially immediately or a pre-determined period of time needs to pass before reactuation of the timing means can take place.

1. An electrical adaptor, said adaptor including:
first electrical connection means for allowing electrical connection of the adaptor with an electrical socket and/or electrical supply in use;
at least second electrical connection means for allowing electrical connection of an electrical plug or further electrical connection with the adaptor; and
timing means for allowing electrical current to be supplied through said adaptor in use for one or more pre-determined time periods;
and wherein said timing means includes at least first and second parts, at least one of said parts capable of undergoing relative movement with respect to said other part in use between a first position, wherein electrical current can flow through said adaptor between the first and at least second electrical connection means, and a second position, wherein electrical current is prevented from flowing through the adaptor between the first and at least second electrical connection means.

2. An electrical adaptor according to claim 1 wherein the time taken for relative movement between the at least first and/or second parts determines or substantially equates to the one or more pre-determined time periods.

3. An electrical adaptor according to claim 1 wherein the adaptor comprises a housing and the first part comprises, is attached to or is integrally formed with said housing.

4. An electrical adaptor according to claim 1 wherein the second part is slidably movable relative to said first part in moving between said first and second positions.

5. An electrical adaptor according to claim 1 wherein the second part is arranged to undergo reciprocal and/or substantially linear movement in moving relative to the first part between said first and second positions in use.

6. An electrical adaptor according to claim 5 wherein the second part is arranged to move outwardly and/or inwardly relative to a recess or aperture defined in first part when moving between said first and second positions in use.

7. An electrical adaptor according to claim 1 wherein a user is required to actuate the timing mechanism for each pre-determined time period to allow relative movement between the at least first and/or second parts between the first and second positions.

8. An electrical adaptor according to claim 7 wherein the second part is arranged to be pushed inwardly of or relative to the first part to allow actuation of the timing mechanism.

9. An electrical adaptor according to claim 1 wherein the adaptor includes biasing means for biasing the second part from the first position to the second position.

10. An electrical adaptor according to claim 9 wherein the biasing means includes any or any combination of resilient biasing means, pneumatic means, hydraulic means or mechanical means.

11. An electrical adaptor according to claim 1 wherein movement means are associated with or form part of the timing means, the movement means including any or any combination of resilient biasing means, pneumatic means, hydraulic means or mechanical means.

12. An electrical adaptor according to claim 1 wherein the housing of the adaptor includes a number of separate walls and/or faces and the first and second electrical connection means and the second part are each provided on separate walls or faces.

13. An electrical adaptor according to claim 1 wherein a recess or aperture is defined in the first part and the second part is located at least partially in the recess or aperture.

14. An electrical adaptor according to claim 1 wherein a front surface of the second part is substantially flush with a front surface of the first part when the adaptor is in the second position.

15. An electrical adaptor according to claim 13 wherein the second part is recessed further within said recess or aperture when the adaptor is in the first position compared to when the adaptor is in the second position.

16. An electrical adaptor according to claim 1 wherein sealing means are provided in or on the adaptor to prevent dirt and/or moisture from entering the adaptor interior.

17. An electrical adaptor according to claim 1 wherein control means are provided on or associated with the adaptor for allowing the timing means to be moved between “on” and “off” conditions.

18. An electrical adaptor according to claim 17 wherein with the control means in the “off” condition, the adaptor can be used in a conventional manner for a time period exceeding said one or more pre-determined time periods.

19. An electrical adaptor according to claim 1 wherein written instructions, symbols or arrows are provided on said adaptor to allow a user to determine how to actuate said adaptor.

20. An electrical adaptor according to claim 1 wherein the one or more pre-determined time periods are pre-determined by the manufacturer.

21. A method of using an electrical adaptor, said method including the steps of:
engaging first electrical connection means of the adaptor with an electrical socket and/or electrical supply;
engaging at least second electrical connection means of the adaptor with an electrical plug or further electrical connection;
and actuating timing means on said adaptor to allow electrical current to flow through said electrical adaptor for one or more pre-determined time periods;
and wherein said timing means includes at least first and second parts, at least one of said parts capable of undergoing relative movement with respect to said other part following actuation between a first position, wherein electrical current can flow through said adaptor between the first and at least second electrical connection means, and a second position, wherein electrical current is prevented from flowing through the adaptor between the first and at least second electrical connection means.
